(19) United States
(12) Patent Application Publication
(10) Pub. No.: US 2016/0035050 A1
(43) Pub. Date: Feb. 4, 2016

(54) METHOD AND APPARATUS FOR DEVICE MANAGEMENT BASED ON DEVICE POWER INFORMATION AND PRICING SCHEMES

(71) Applicant: Samsung Electronics Co., Ltd., Suwon-si (KR)

(72) Inventors: Chungsuk HAN, Seongnam-si (KR); Dongseop LEE, Suwon-si (KR)

(21) Appl. No.: 14/811,195

(22) Filed: Jul. 28, 2015

(30) Foreign Application Priority Data
Jul. 30, 2014 (KR) 10-2014-0097300

(51) Int. Cl. G06Q 50/06; H02J 4/00; H02J 7/00

(52) U.S. Cl. CPC G06Q 50/06; H02J 7/007; H02J 4/00

(57) ABSTRACT

A device management method of a server and an apparatus for managing a device based on power information and pricing schemes are provided. The method includes receiving information used for creating device power control information that is used for changing a power mode between alternating current (AC) power and direct current (DC) power to incur a minimum price, calculating a plurality of times a device is capable of operating with DC power, based on a plurality of operating rates of at least one component of the device obtained from the received information, creating first device power control information based on a battery available time selected from the calculated plurality of times by a predetermined policy, and controlling the device according to the created first device power control information.

### CROSS-REFERENCE TO RELATED APPLICATION(S)

This application claims the benefit under 35 U.S.C. §119(a) of a Korean patent application filed on Jul. 30, 2014 in the Korean Intellectual Property Office and assigned Serial number 10-2014-0097300, the entire disclosure of which is hereby incorporated by reference.

### TECHNICAL FIELD

The present disclosure relates to power control technology. More particularly, the present disclosure relates to a method and apparatus for managing a device based on power information and pricing schemes.

### BACKGROUND

In order to more effectively use limited energy resources and reduce energy consumption, a plan of differentiating energy prices according to time zones or seasons has been recently considered.

Meanwhile, energy consumption of computers is about twelve percent of the total energy in a commercial building and is about nine percent of the total energy in a residential building.

Therefore, there is a need for energy usage that makes it possible to reduce power consumption at a higher-rate time zone in view of fluctuations in energy prices.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a device managing method and apparatus that can use power more effectively by selecting a zone for using direct current (DC) power based on a rate system varying according to time, power device information and device usage information and then by setting control information (hereinafter referred to as DC change information) for changing a power use mode between alternating current (AC) power and DC power.

In accordance with an aspect of the present disclosure, a server of a device management system based on device power information is provided. The server includes a transceiver unit configured to receive information used for creating device power control information that is used for changing a power mode between AC power and DC power to incur a minimum price, and a control unit configured to calculate a plurality of times a device is capable of operating with DC power, based on a plurality of operating rates of at least one component of the device obtained from the received information, to create first device power control information based on a battery available time selected from the calculated plurality of times by a predetermined policy, and to control the device according to the created first device power control information.

In accordance with another aspect of the present disclosure, a device of a device management system based on device power information is provided. The device includes a transmission unit configured to transmit information used for creating device power control information that is used for changing a power mode between AC power and DC power to incur a minimum price, and a control unit configured to receive a result of calculating a plurality of times a device is capable of operating with DC power, based on a plurality of operating rates of at least one component of the device obtained from the received information, to receive first device power control information created depending on a battery available time selected from the calculated plurality of times by a predetermined policy, and to control the device according to the received first device power control information.

In accordance with another aspect of the present disclosure, a device management method of a server based on device power information is provided. The device management method includes receiving information used for creating device power control information that is used for changing a power mode between AC power and DC power to incur a minimum price, calculating a plurality of times a device is capable of operating with DC power, based on a plurality of operating rates of at least one component of the device obtained from the received information, creating first device power control information based on a battery available time selected from the calculated plurality of times by a predetermined policy, and controlling the device according to the created first device power control information.

In accordance with another aspect of the present disclosure, a management system of a device based on device power information is provided. The management system includes of transmitting information used for creating device power control information that is used for changing a power mode between AC power and DC power to incur a minimum price, receiving a result of calculating a plurality of times a device is capable of operating with DC power, based on a plurality of operating rates of at least one component of the device obtained from the received information, receiving first device power control information created depending on a battery available time selected from the calculated plurality of times by a predetermined policy, and controlling the device according to the received first device power control information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating elements of a device managing method according to an embodiment of the present disclosure;

FIG. 2 is a diagram illustrating a process of creating, at a server, device power control information by using a power pricing scheme and device information according to an embodiment of the present disclosure;

FIG. 3A is a flow diagram illustrating a process of creating, at a server, device power control information of FIG. 2 according to an embodiment of the present disclosure;

FIG. 3B is a flow diagram illustrating a process of creating, at a server, device power control information at operation S330 of FIG. 3A according to an embodiment of the present disclosure;

FIG. 4 is a detailed diagram illustrating a process of performing, at a server, management level modeling at operation S320 of FIG. 3A according to an embodiment of the present disclosure;

FIG. 5 is a detailed diagram illustrating a process of creating, at a server, device power control information at operations S320 and S330 according to an embodiment of the present disclosure;

FIG. 6 is a detailed diagram illustrating a process of creating, at a server, first device power control information at operation S330 according to an embodiment of the present disclosure;

FIG. 7 is a diagram illustrating a process of creating, at a server, device power control information when a specific event occurs according to an embodiment of the present disclosure;

FIG. 8 is a diagram illustrating a process of determining, at a server, operating rates of components by using user's device usage information so as to create device power control information when a specific event occurs according to an embodiment of the present disclosure;

FIG. 9 is a flow diagram illustrating a process of creating, at a server, device power control information when a specific event occurs according to an embodiment of the present disclosure;

FIG. 10 is a flow diagram illustrating a process of creating, at a server, device power control information by considering a case of having no battery according to an embodiment of the present disclosure;

FIG. 11 is a flow diagram illustrating a process of creating, at a server, second device power control information according to an embodiment of the present disclosure; and

FIG. 12 is a block diagram illustrating an internal structure of a device managing server according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

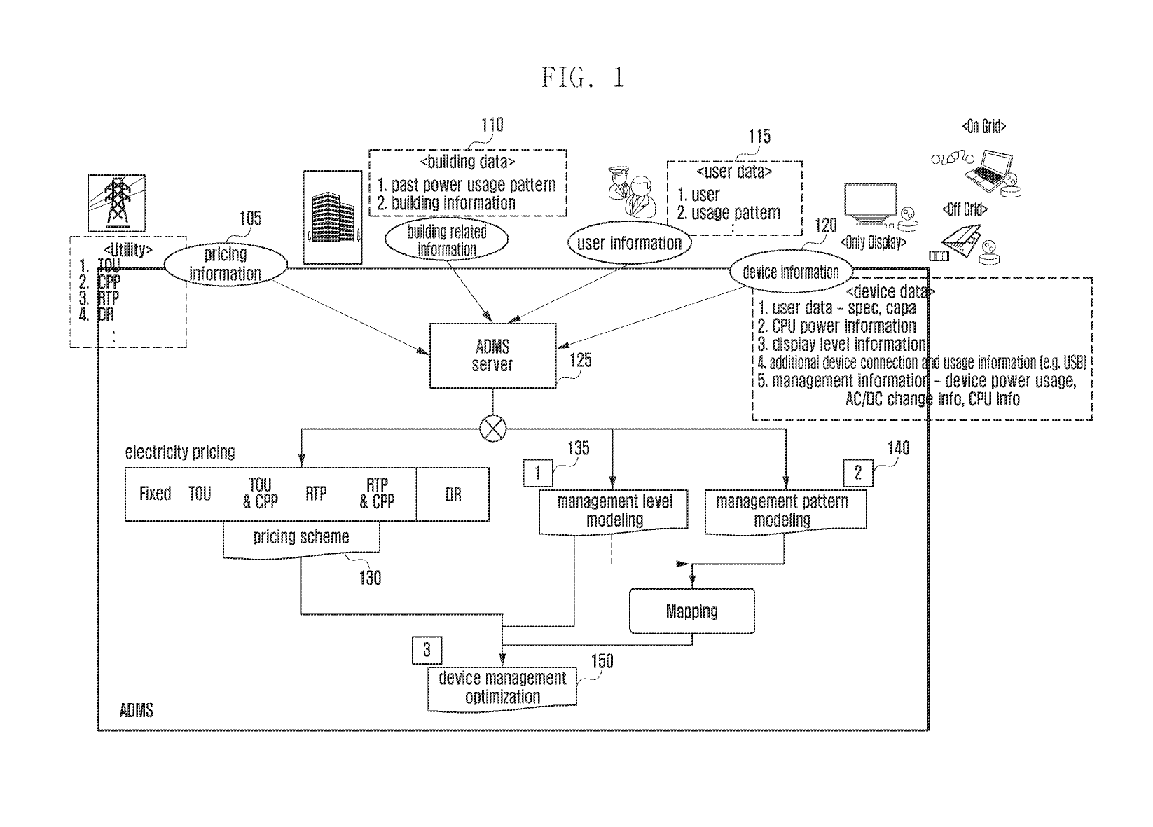

FIG. 1 is a diagram illustrating elements of a device managing method according to an embodiment of the present disclosure.

Referring to FIG. 1, a server 125 is configured to receive information used for creating device power control information and also to create the device power control information by using the received information. Here, the device power control information refers to information used for changing a power use mode between alternating current (AC) power and direct current (DC) power in order to incur a minimum price. In the present disclosure, device power control information and DC change information may be used as the same meaning.

The information, which the server 125 receives to create the device power control information, may include at least one of pricing information 105, building related information 110, user information 115, and device information 120.

The pricing information 105 may include information about power pricing schemes determined by utility companies. Types of such power pricing schemes may be, for example, real time pricing (RTP), critical peak pricing (CPP), and time of use (TOU).

RTP refers to a pricing scheme in which the electricity price is varied according to time zones based on wholesale or retail prices. Although there is a similarity between RTP and TOU in that the electricity price is time-dependent, RTP is different from TOU in that the electricity price is varied depending on a power grid management and a supply situation. Therefore, RTP should offer variable prices to consumers in real time (e.g., at least every 5 minutes). While RTP has a higher variability of electricity price in comparison with TOU, RTP can increase the benefit of both a supplier and a consumer if consumers use electric power economically. In RTP, customer baseline load (CBL) and a standard price may be established. The standard price may be applied to power usage below CBL, and RTP is applied to power usage exceeding CBL. This may relieve the variability of electricity price.

TOU refers to a pricing scheme for imposing electricity prices differentially in the form of a double shift (i.e., on-peak and off-peak) or a triple shift when there are wide differences of power consumption according to seasons and time zones. This scheme focuses on a statistical approach without considering a power market situation in real time.

CPP refers to a pricing scheme that allows a supplier to use peak rating when the power grid has the problem of reliability or when the wholesale price skyrockets. CPP may be applied, together with TOU, etc., to a limited time a year.

A demand response (DR) signal refers to a situation in which an end consumer uses electric power out of a normal consumption pattern in response to monetary incentive or instructions of a utility company. The utility company usually supplies the monetary incentive to encourage end consumers to reduce power consumption to cope with a situation that the wholesale price rises or the reliability of the power grid is threatened. By sending the DR signal in case estimated power usage is higher than power storage, the utility company encourages consumers to reduce power consumption.

Among several kinds of information for creating the device power control information, the building related information 110 refers to information obtained by analyzing a power usage pattern of a building. Using the pricing information 105 and the building related information 110, the server 125 can select the optimal pricing scheme suitable for the relevant building from among a plurality of pricing schemes included in the pricing information 105. Since this technique to select a pricing scheme is apparent to those skilled in the art, the present disclosure assumes that the optimal pricing scheme is selected for each building.

Among several kinds of information for creating the device power control information, the user information 115 refers to user identification information, user's device usage information, and the like. The user's device usage information refers to information about a pattern of using respective device components by each user. For example, if a device is a notebook, the user information 115 may include a usage pattern of a central processing unit (CPU), a display, or any other component. Namely, the user information 115 may refer to a usage pattern of each device component, varying according to the type or purpose of a device, a user's setting, or the like. The user information 115 may be used for a management pattern modeling process 140.

Among several kinds of information for creating the device power control information, the device information 120 refers to information associated with the amount of power consumed by a relevant device or components thereof For example, if a device is a notebook, the device information 120 may include a battery capacity, CPU power information, display level information, additional device connection and usage information, device power usage, and the like. The device information 120 may be used for a management level modeling process 135.

Using the pricing information 105, the building related information 110, the user information 115, and the device information 120 as discussed above, the server 125 can create the device power control information. Specifically, the device power control information may be created through the management level modeling process 135 and a device management optimizing process 150.

The management level modeling process 135 refers to a process of calculating time information capable of operating a device with DC power, based on a plurality of operating rates of at least one component of the device obtained from the device information 120. An operating rate of a device component refers to the output against the maximum output of the device component. The management level modeling process 135 calculates time information with regard to each operating rate of each component.

After the management level modeling process 135 is performed, the server 125 may optimize the management of devices based on management level modeling results.

The device management optimizing process 150 refers to a process of creating optimized device management information by using a pricing scheme 130 and the result of the management level modeling process 135. In the present disclosure, such optimized device management information refers to control information that instructs a change in a power use mode between AC power and DC power in order to incur a minimum price. As discussed above, this information may be also referred to as device power control information or DC change information. A detailed process of creating the device power control information according to the result of the management level modeling process 135 will be described later.

Meanwhile, if a specific event occurs, the server 125 performs the management pattern modeling process 140. For example, a specific event may be a case of receiving a DR signal. When any DR signal is received, the server 125 should reduce power consumption in order to avoid excessive prices. In this case, it is therefore important to find a range of causing no inconvenience to a user.

The management pattern modeling process 140 refers to a process of modeling relations between a device component and an operating rate range for allowing a user to use the device component. A pattern obtained in this modeling process is referred to as a device management pattern. By analyzing a user's device usage pattern from the device management pattern, it is possible to reduce power consumption within a range of causing no inconvenience to a user.

After such a range for reducing power consumption is determined through the management pattern modeling process 140, the server 125 can create new device power control information by using the result of the management level modeling process 135 and the determined range. A detailed process will be described further below.

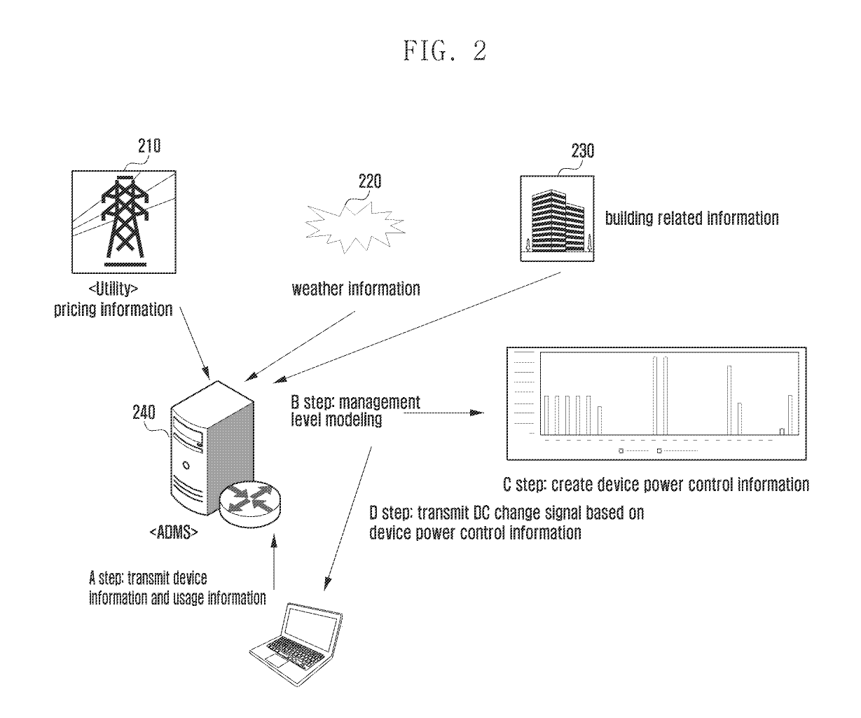

FIG. 2 is a diagram illustrating a process of creating, at a server, device power control information by using a power pricing scheme and device information according to an embodiment of the present disclosure.

Referring to FIG. 2, at operation A, the server 240 receives pricing information 210, weather information 220, building related information 230, device information, and device usage information.

At operation B, the server 240 performs a management level modeling process by using the received device information. Based on a predetermined policy, the server 240 may select a battery available time for a device from among time information obtained as the result of the management level modeling process. The battery available time refers to a time period capable of operating the device by using a battery. The battery available time is used for setting constraints used for creating the device power control information. The details thereof will be given further below.

At operation C, the server 240 creates the device power control information by using the battery available time. Namely, the server 240 creates control information for a change in a power use mode between AC power and DC power so that the minimum price can be incurred. In the present disclosure, the battery available time and the battery total capacity are used as the same meaning. Also, the battery available time may be expressed as B_{capa}.

At operation D, the server 240 transmits the device power control information created at operation C to the device. Then, based on the received power control information, the device can be controlled to change a power use mode between AC power and DC power. Alternatively, the server 240 may directly control the device without transmitting the device power control information to the device.

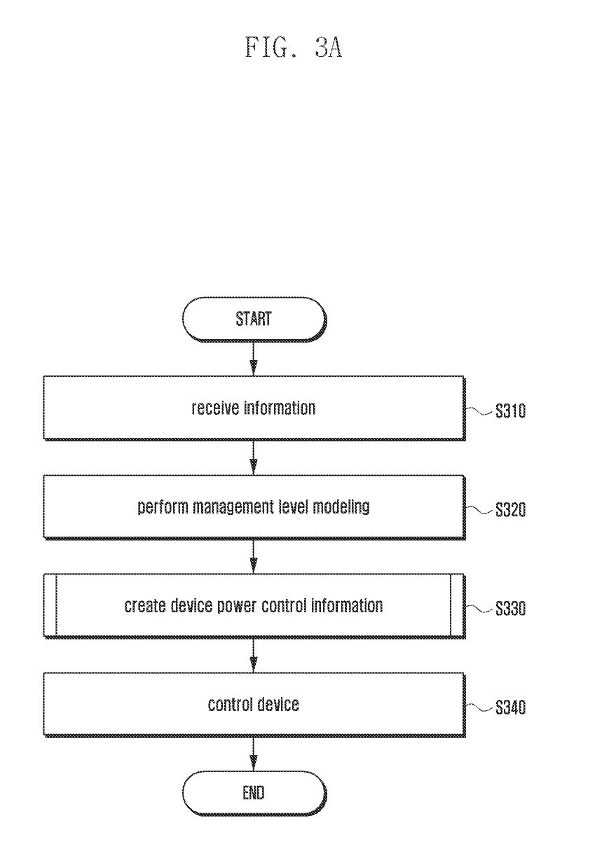

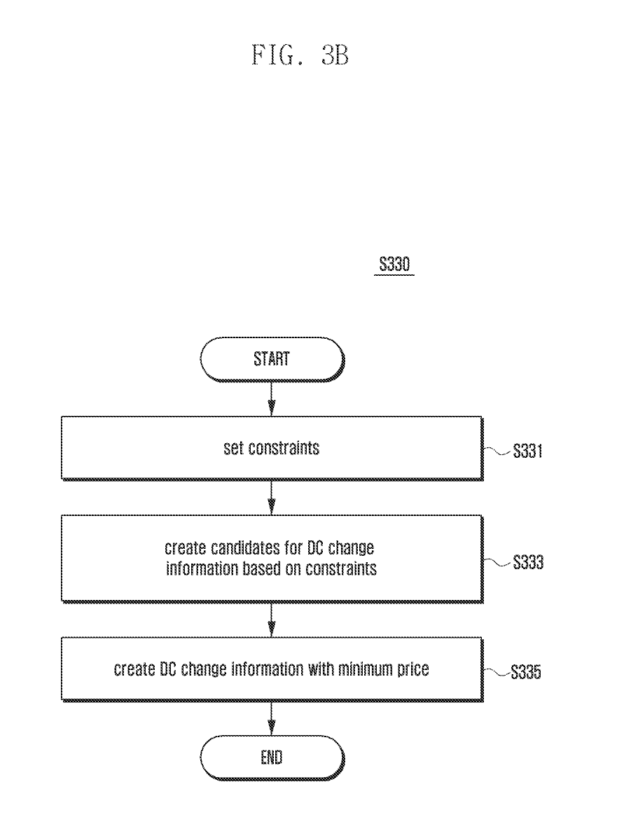

FIG. 3A is a flow diagram illustrating a process of creating, at the server, the device power control information of FIG. 2 according to an embodiment of the present disclosure.

Referring to FIG. 3A, at operation S310, the server receives information for creating the device power control information. Such received information may include at least one of pricing information, building related information, user information, and device information.

At operation S320, the server performs a management level modeling process by using the received device information. Specifically, the server can perform a modeling process by using the power consumption depending on operating rates of device components and the battery total capacity contained in the received device information. After this modeling process is performed, the server may select, based on a predetermined policy, a battery available time for a device from among time information obtained as the result of the management level modeling process.

At operation S330, the server creates device power control information by using the selected battery available time. Also, the server may set constraints by using the battery available time. The device power control information may be created within a range of satisfying the constraints. As discussed above, the device power control information or DC change information refers to control information for changing a power use mode between AC power and DC power so that the minimum electricity price can be incurred.

At operation S340, the server can control a device by using the created device power control information. Alternatively, the server can transmit the device power control information to the device, and then the device can be controlled according to the received device power control information.

FIG. 3B is a flow diagram illustrating a process of creating, at the server, the device power control information at operation S330 of FIG. 3A according to an embodiment of the present disclosure.

Referring to FIG. 3B, at operation S331, the server sets constraints. DC power is restricted in use by parameters such as a battery available time, a battery charge quantity, a battery discharge quantity, and the like. Therefore, the server should set the DC change information within a range that satisfies constraints.

At operation S333, the server creates candidates for the DC change information that satisfies the constraints. Additionally, at operation S335, the server calculates an electricity price incurred with regard to each candidate for the DC change information. Based on the result of calculation, specific DC change information that incurs the minimum price is set as the device power control information.

For example, candidates for the DC change information may be expressed as DC₁=[000000011001011000000000], DC₂=[00000010001110000000000], and the like. In this example, the DC change information is formed of twenty-four digits corresponding to 24 hours a day. Further, the Arabic numbers 0 and 1 denote charge and discharge, respectively. Namely, a time zone allotted the Arabic number 1 refers to the use of DC power, and a time zone allotted the Arabic number 0 refers to the use of AC power. Additionally, this information may be formed of a charge quantity and a discharge quantity. As the result of calculation, if the electricity price of DC₁ is relatively low, the server determines DC₁ as the device power control information. A detailed method of calculating electricity prices will be described further below.

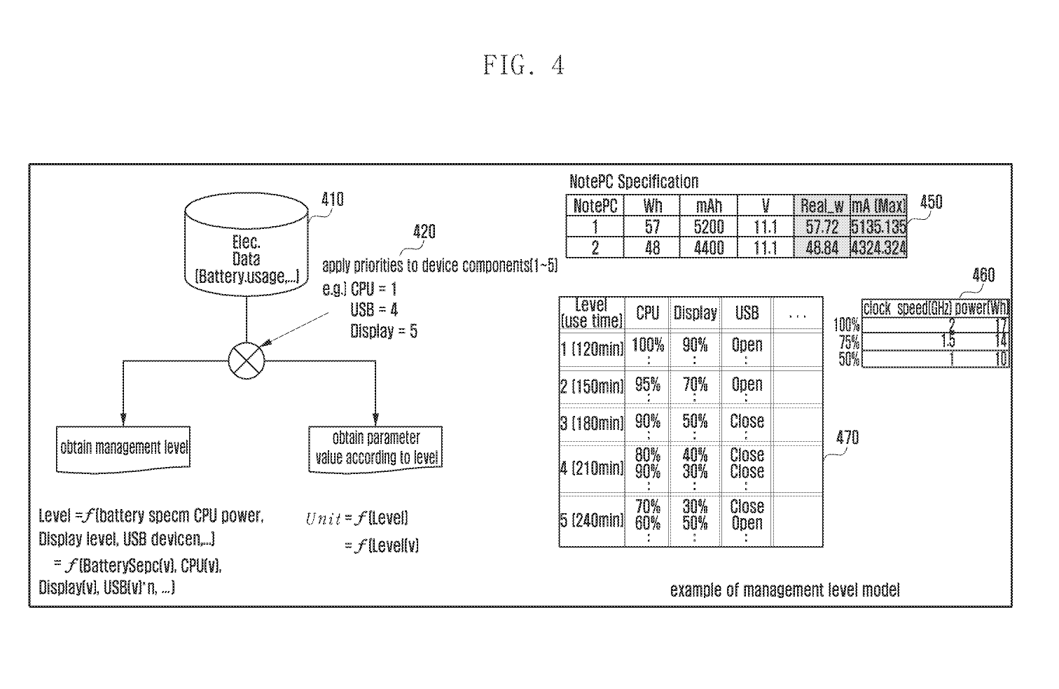

FIG. 4 is a detailed diagram illustrating a process of performing, at the server, management level modeling at operation S320 of FIG. 3A according to an embodiment of the present disclosure.

Referring to FIG. 4, the management level modeling process refers to a process of calculating time information capable of operating a device with DC power, based on operating rates of at least one component of the device obtained from device information 410.

In order to perform the management level modeling process, the server receives the device information 410, which may include at least one of a battery specification, CPU power, a display level, and universal serial bus (USB) data.

In FIG. 4, tables 450 and 460 show examples of the device information 410. Specifically, the table 450 shows power, voltage and current consumed by a notebook, and the table 460 shows power consumption depending on a clock speed.

Using the device information 410, the server can find a usable time depending on operating rates of device components in a case of using DC power. For example, in the table 450, the first notebook (note personal computer (PC) consumes power of 57.72 W. If the table 460 shows power consumption according to a clock speed of the CPU in the first notebook, the first notebook consumes power of 17 W per hour in a case of a clock speed of 100%. Therefore, if the CPU only is used at a clock speed of 100%, the first notebook may be used for about 3 hours and 23 minutes. Meanwhile, in a case of a notebook, power consumption of the display should be further considered. If the display consumes power of 11 W per hour in a case of an operating rate of 100%, and if the first notebook is used at a CPU clock speed of 100% and a display operating rate of 100%, the first notebook may be used for about 2 hours. In such a manner, the modeling of relations between the operating rate of each device component and the device available time can be performed.

In FIG. 4, a table 470 shows the result of modeling. In the table 470, the level 1 is defined as case where a CPU operating rate is 100% and a display operating rate is 90%. Namely, the level 1 indicates that a usable time is 120 minutes when a CPU operating rate is 100% and a display operating rate is 90%. Such a level may indicate a time period capable of operating a device.

Similarly, the level 4 is defined as case where a CPU operating rate is 80% and a display operating rate is 40%. Namely, the level 4 indicates that a usable time is 210 minutes when a CPU operating rate is 80% and a display operating rate is 40%. Additionally, the level 4 is further defined as case where a CPU operating rate is 90% and a display operating rate is 30%. Namely, the level 4 also indicates that a usable time is 210 minutes when a CPU operating rate is 90% and a display operating rate is 30%.

Here, a CPU operating rate of 90% may indicate that the clock speed of the CPU is adjusted to 90%. Additionally, a display operating rate of 70% may indicate that 70% of the maximum power is consumed.

Meanwhile, the server may perform the management level modeling process by applying priorities to device components as indicated by a reference number 420. Alternatively, the server may perform the management level modeling process without priority.

If a modeling result of the device is predetermined, the server may use such a result as it is since a modeling result is determined depending on the device information.

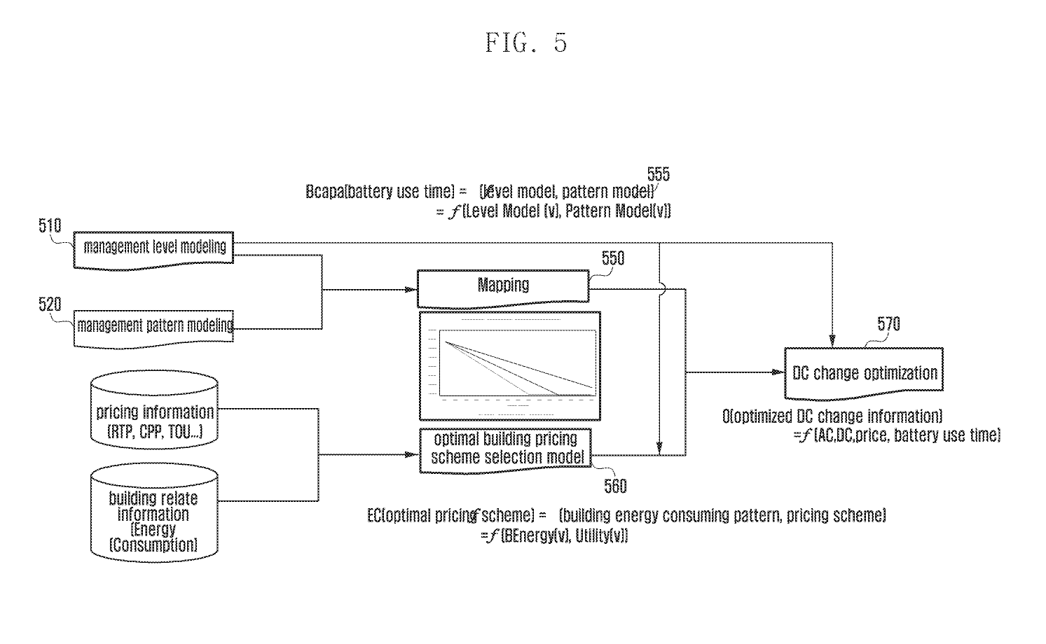

FIG. 5 is a detailed diagram illustrating a process of creating, at the server, the device power control information at operations S320 and S330 according to an embodiment of the present disclosure.

After the management level modeling process is performed as shown in FIG. 4, the server may select, based on a predetermined policy, a battery available time for a device from among time information obtained as the result of the management level modeling process. The predetermined policy may be a building management policy. For example, a DC power usable time (i.e., the battery available time) may be set to four hours so as to reduce power consumption by company policy. When the battery available time is selected in such a manner, the server may determine a level from the result of the management level modeling process. For example, the level 5 may be selected in the table 470 shown in FIG. 4. Therefore, the server can determine operating rates of respective device components corresponding to the selected level.

Referring to FIG. 5, the battery available time is used as constraints on the creation of the DC change information. Using the constraints and an optimal building pricing scheme 560, the server creates optimized DC change information. The details thereof will be given further below.

In an embodiment of the present disclosure, if a specific event occurs, the server performs a management pattern modeling process 520 and then, at mapping operation 550, calculates a battery available time for a device by using the result of the management pattern modeling process 520, the result of a management level modeling process 510, and equation 555. Then, at operation 570, the server creates optimized DC change information by using the calculated battery available time.

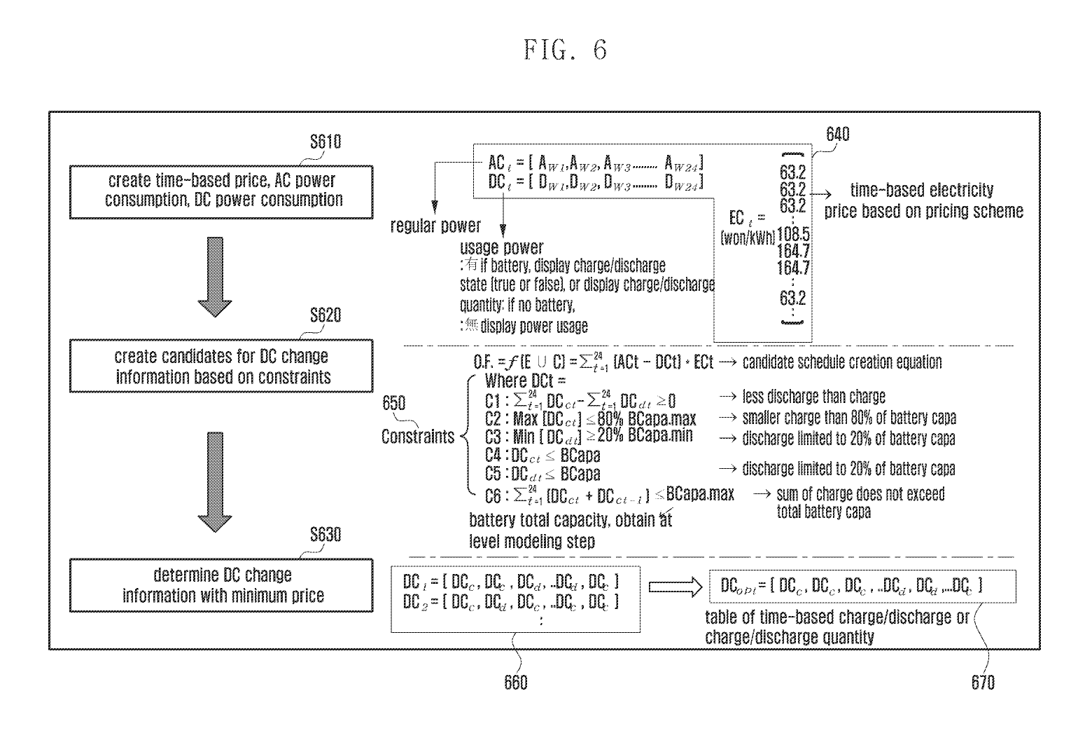

FIG. 6 is a detailed diagram illustrating a process of creating, at the server, the first device power control information at operation S330 according to an embodiment of the present disclosure.

Referring to FIG. 6, at operation S610, the server may create a time-based electricity price (e.g., electricity price per hour), time-based AC power consumption (e.g., AC power per hour), and time-based DC power consumption (e.g., DC power per hour). Here, the AC power consumption indicates regular power and a time-based value thereof is a constant. The time-based electricity price is fixed when an optimal pricing scheme is used for each building. The time-based DC power consumption may be expressed as a charge or discharge state and also expressed as a charge or discharge quantity. If any device has no battery, the DC power consumption may be expressed as power usage (W). A reference number 640 shows an example of the created time-based electricity price, time-based AC power consumption, and time-based DC power consumption.

At operation S620, the server may set constraints and then create candidates for DC change information that satisfies the constraints.

DC power is restricted in use by parameters such as the battery available time, the battery charge quantity, the battery discharge quantity, and the like. Therefore, the server should set constraints, which may use the battery available time in FIG. 5. For example, the constraints may have forms as indicated by a reference number 650. Namely, the constraints may be set as follows: i) the discharge quantity should be less than the charge quantity, ii) the charge/discharge quantities do not exceed the total battery capacity, iii) the charge quantity is smaller than 80% of the total battery capacity, iv) in a case of discharge, the limitation is 20% of the total battery capacity, and the like. Such constraints may use the predetermined battery available time and be set by the server or user. For example, the server may set the charge quantity to 70% of the battery available time. Also, the server or user may add or delete constraints.

After the constraints are set, the server creates candidates for the DC change information within a range of satisfying the constraints. The reason that candidates for the DC change information are created is that the server calculates electricity prices of such candidates and then selects the DC change information for incurring the minimum price. A reference number 660 shows an embodiment of the created candidates for the DC change information. In this example, DC₁ and DC₂ indicate different candidates. Also, DC_{c} and DC_{d} denote charge and discharge cases, respectively. In these candidates, the device uses AC power at the time of DC_{c} and supplies DC power at the time of DC_{d}.

At operation S630, the server calculates an electricity price of each candidate for the DC change information and then determines the DC change information that incurs the minimum price. The determined information may become the device power control information. The electricity price may be calculated using Equation 1 given below.

$${\sum }_{t = 1}^{24} ( ACt - DCt ) * ECt \qquad Equation 1$$

In Equation 1, the electricity price can be obtained by multiplying an electricity price per hour and a difference between AC power per hour and DC power per hour and then by adding up such results for 24 hours. The reason that DC power is subtracted from AC power is that a time zone using DC power incurs no electricity price because of using no AC power. A reference number 670 shows an embodiment of the DC change information that incurs the minimum price. Once such information is determined, the server controls the power use mode to be changed from AC to DC when the information indicates a change from DC_{c} and DC_{d}, and also controls the power use mode to be changed from DC to AC when the information indicates a change from DC_{d} and DC_{c}. Alternatively, the server may send the DC change information to the device so that the device can change the power use mode.

The DC change information may be created periodically or in response to the occurrence of a specific event. Such a period may be defined by a user. Based on this period, the server may create the device power control information.

In case a specific event occurs, the server may create new device power control information and then control the device.

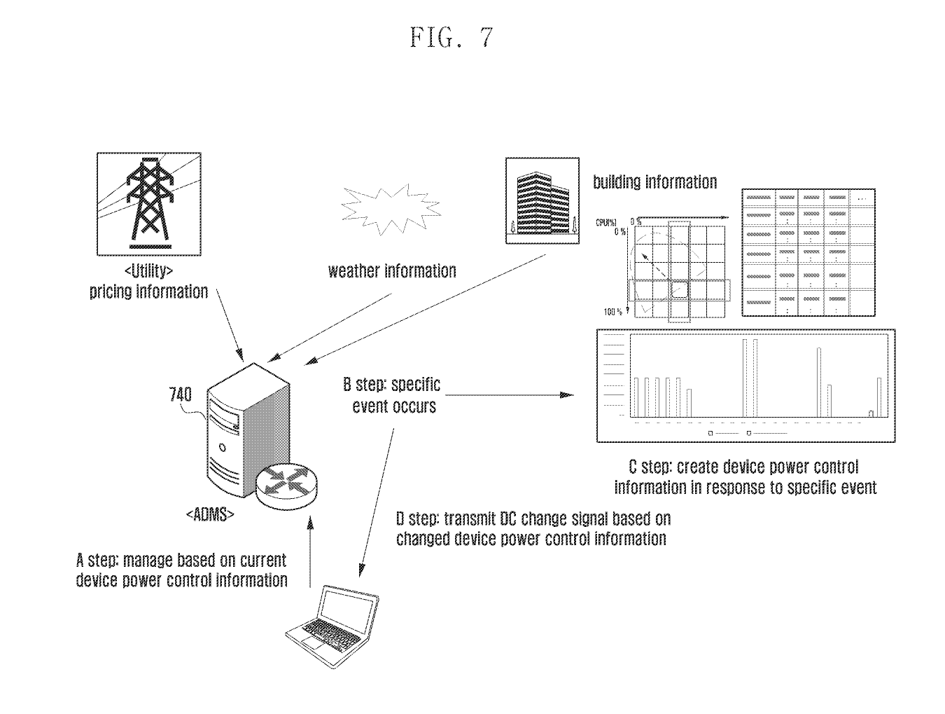

FIG. 7 is a diagram illustrating a process of creating, at the server, the device power control information when a specific event occurs according to an embodiment of the present disclosure.

Referring to FIG. 7, at operation A before a specific event occurs, the server 740 manages the device, based on current device power control information.

At operation B, if a specific event occurs, for example, when a DR signal is received, the server 740 should reduce power usage of the device. Further, such a reduction should be made within a range of causing no inconvenience to a user.

In order to determine a range of reducing power usage, the server 740 may find a user's management pattern by using the already received user's device usage information. The server 740 may determine the operating rate of a new device component by using the management pattern and also create new device power control information by using the operating rate of a device component.

At operation C, the server 740 may create new device power control information by using the determined operating rate of a device component. Also, the server 740 may find a new battery available time by mapping between the determined operating rate of a device component and the result of management level modeling. Thereafter, the server 740 may create new device power control information by using the battery available time.

At operation D, the server 70 transmits the new device power control information created at operation C to a device. Then the device may control itself, based on the received device power control information. Alternatively, the server 740 may directly control the device by using the device power control information without transmitting it to the device.

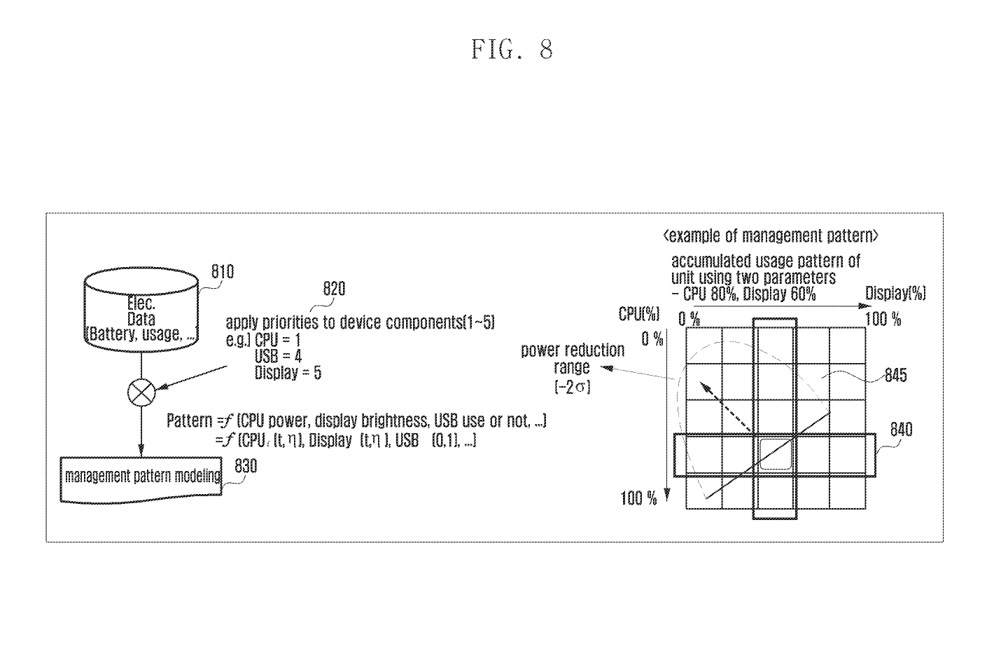

FIG. 8 is a diagram illustrating a process of determining, at the server, operating rates of components by using user's device usage information so as to create the device power control information when a specific event occurs according to an embodiment of the present disclosure.

Referring to FIG. 8, at management pattern modeling operation 830, the server analyzes user's device usage information 810 and thereby obtains a device management pattern. For example, even in cases of using the same notebooks, a CPU clock speed, display brightness, etc. of each notebook may be varied according to the purpose of the notebook, a user's setting, or the like. The result of analyzing each user's pattern of using device components is referred to as a device management pattern.

The server may apply priorities to device components as indicated by a reference number 820 and thereby perform a management pattern modeling process 830. Alternatively, the server may perform the management pattern modeling process 830 without priority.

A reference number 840 shows an embodiment of a user's management pattern, which may indicate that a user mostly uses the CPU at an operating rate of 80% and the display at an operating rate of 60%.

After the management pattern modeling process 830 is performed, the server may determine a power reduction range 845. The power reduction range 845 may refer to a particular range of reducing the operating rates of device components by using a management pattern within a range of causing no inconvenience to a user. The power reduction range 845 may be determined using the device management pattern. For example, the server may determine the power reduction range 845 to be twice a standard deviation calculated from the management pattern. For example, as the result of the management pattern modeling process, the server may obtain a result indicating that a user mostly uses the CPU at an operating rate of 80% and the display at an operating rate of 60%. If a usage range of the CPU and display calculated from the management pattern has the standard deviation of 5%, it is possible to reduce the CPU operating rate up to 70% and reduce the display operating rate up to 50%. The server may determine the power reduction range 845 in various manners.

When the server determines the power reduction range and thereby reduces operating rates, the battery available time of the device is changed. Therefore, the server should find a new battery available time.

The battery available time is obtained using the result of the management level modeling process. Namely, by mapping between the operating rates depending on the determined power reduction range and the result of the management level modeling, the battery available time can be obtained.

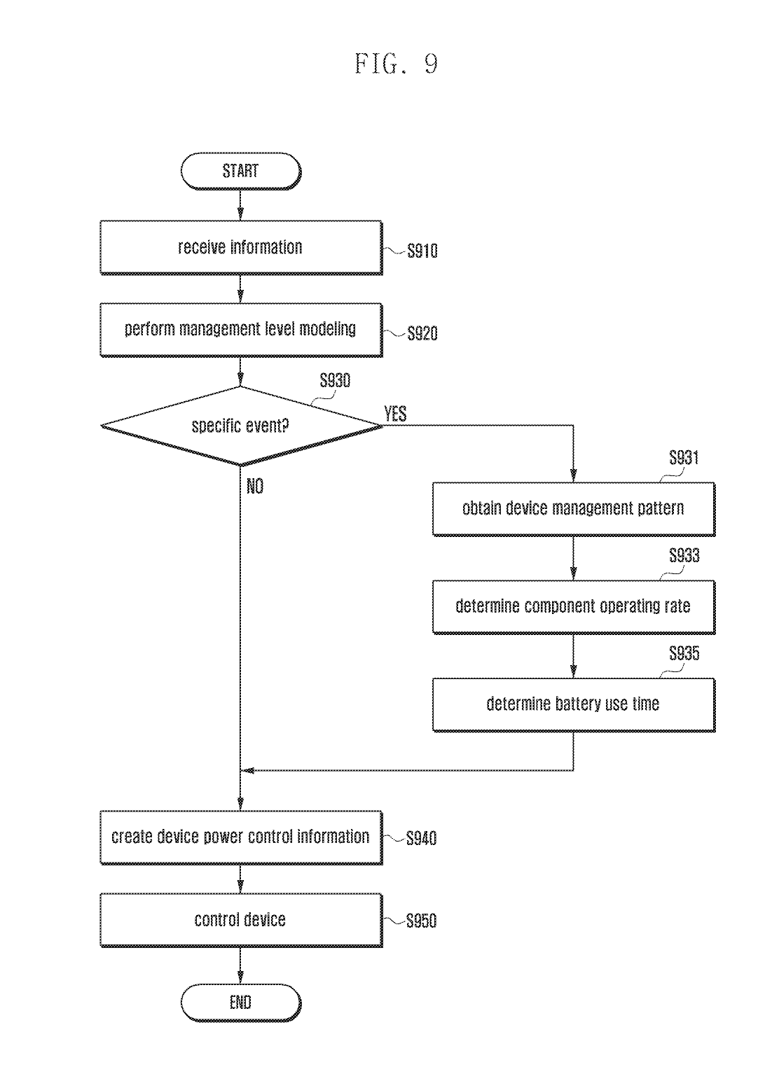

FIG. 9 is a flow diagram illustrating a process of creating, at the server, the device power control information when a specific event occurs according to an embodiment of the present disclosure.

Referring to FIG. 9, at operation S910, the server receives information used for creating the device power control information. Additionally, at operation S920, the server performs the management level modeling process. This process is the same as the process discussed in previous embodiments of the present disclosure. If the modeling result of the device is predetermined, the result may be used as it is.

At operation S930, the server determines whether a specific event occurs. If no specific event occurs, the server creates the device power control information in a manner previously discussed in FIG. 2.

If a specific event occurs, the server obtains the device management pattern at operation S931 by analyzing user's device usage information received at operation S910.

At operation S933, the server determines the operating rate of each device component by using the obtained management pattern. Namely, based on the obtained management pattern, the server determines the operating rates of the respective device components within a range of causing no inconvenience to a user.

At operation S935, the server determines a new battery available time by mapping between the operating rate newly determined at operation S933 and the result of the management level modeling process. A certain level corresponding to the operating rate of the device component may become the battery available time.

At operation S940, the server creates new device power control information by using the battery available time determined at operation S935. The battery available time will be used as constraints on the creation of new device power control information. The process of creating new device power control information is the same as previously discussed in FIG. 6. Thereafter, the device is controlled at operation S950.

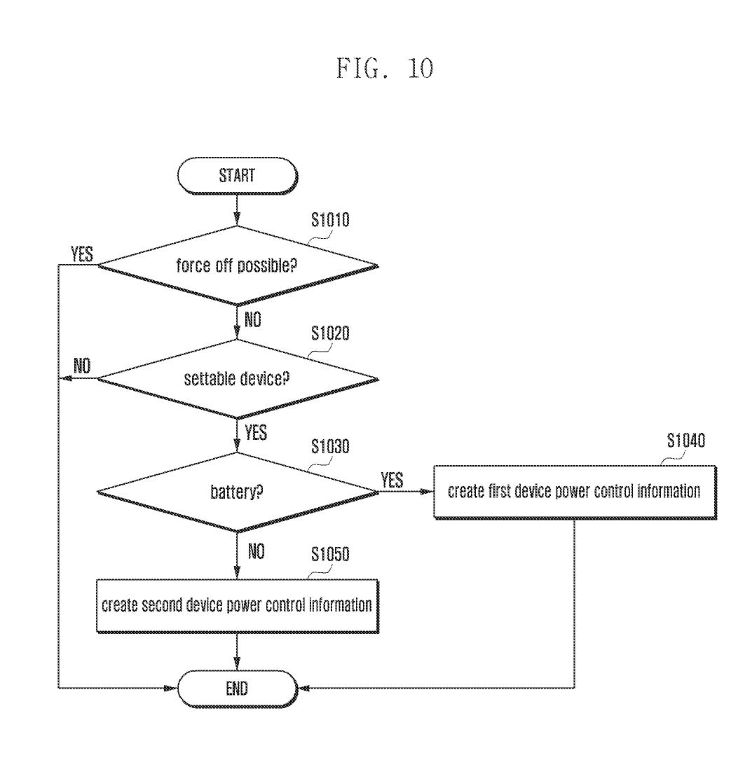

FIG. 10 is a flow diagram illustrating a process of creating, at the server, the device power control information by considering a case of having no battery according to an embodiment of the present disclosure.

The present disclosure may be applied to any device that has no battery and thus disallows a DC change. Even in a case of such a device having no battery, if there is a power reducible component, the server may control such a component to reduce power consumption. Therefore, described hereinafter in this embodiment of the present disclosure is a process, performed by the server, of creating the power reduction information of a power reducible component and thereby reducing power consumption in a case where there is no battery in the device.

Referring to FIG. 10, at operation S1010, the server determines whether the device allows a forced off (namely, forced termination). For this determination, hardware characteristics, software characteristics, user information, etc. are considered. If the device allows a forced off, the server terminates this process without creating the device power control information since power consumption can be reduced through a forced off.

If it is determined that the device disallows a forced off, at operation S1020 the server further determines whether the device is a settable device. In the present disclosure, the settable device refers to a device that allows a DC change. However, if there is a power reducible component even in case a DC change is impossible, the server may control the power reducible component to reduce power consumption. Therefore, if any device has a power reducible component, the server determines that this device is a settable device. If it is determined at operation S1020 that the device is not a settable device, the server terminates this process since a power reduction is not possible.

If it is determined that the device is a settable device, at operation S1030 the server further determines whether there is a battery. If there is a battery, the server creates the first device power control information at operation S1040. If there is no battery, the server obtains information for controlling the power reducible component at operation S1050. For a distinction between the first case of having a battery and the second case of having no battery, the DC change information created in the first case is referred to the first device power control information, and the information created for controlling the power reducible component in the second case is referred to the second device power control information.

A process of creating the second device power control information in a case of having no battery is the same as the above-discussed process of creating the first device power control information in a case of having a battery. Namely, the process shown in FIG. 3A is performed.

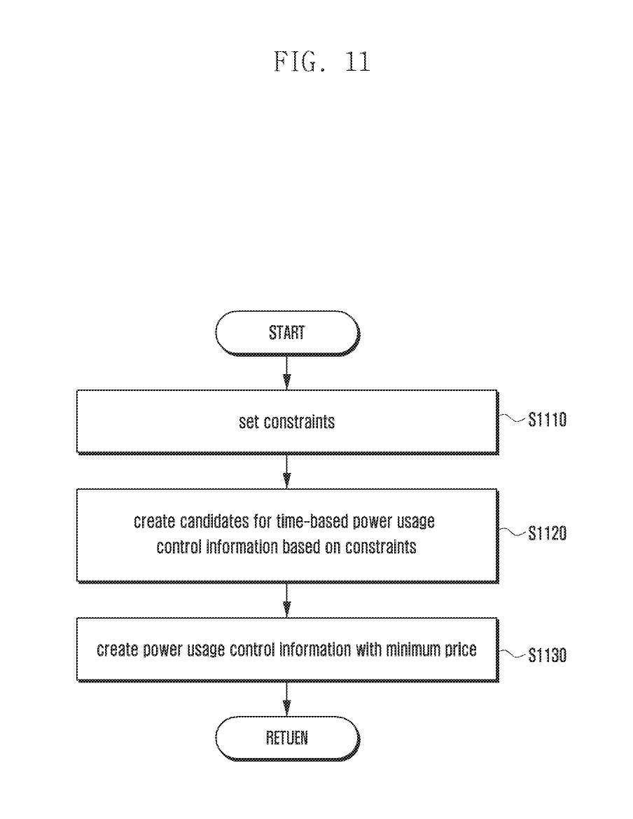

FIG. 11 is a flow diagram illustrating a process of creating, at the server, the second device power control information according to an embodiment of the present disclosure.

Referring to FIG. 11, at operation S1110, the server sets constraints. In the same manner as the process of creating the first device power control information, such constraints use the predetermined management level modeling result.

At operation S1120, the server creates candidates for time-based power usage control information, based on such constraints. Namely, in a case of a device having a battery and allowing the use of DC power, the server creates candidate schedules of DC change information. On the contrary, in a case of a device having no battery, the server creates candidates for time-based power usage control information of power reducible components.

At operation S1130, the server calculates an electricity price incurred with regard to each candidate. Then, from among the calculated electricity prices, the server selects particular control information that incurs the minimum prices. This selected information is determined as the second device power control information.

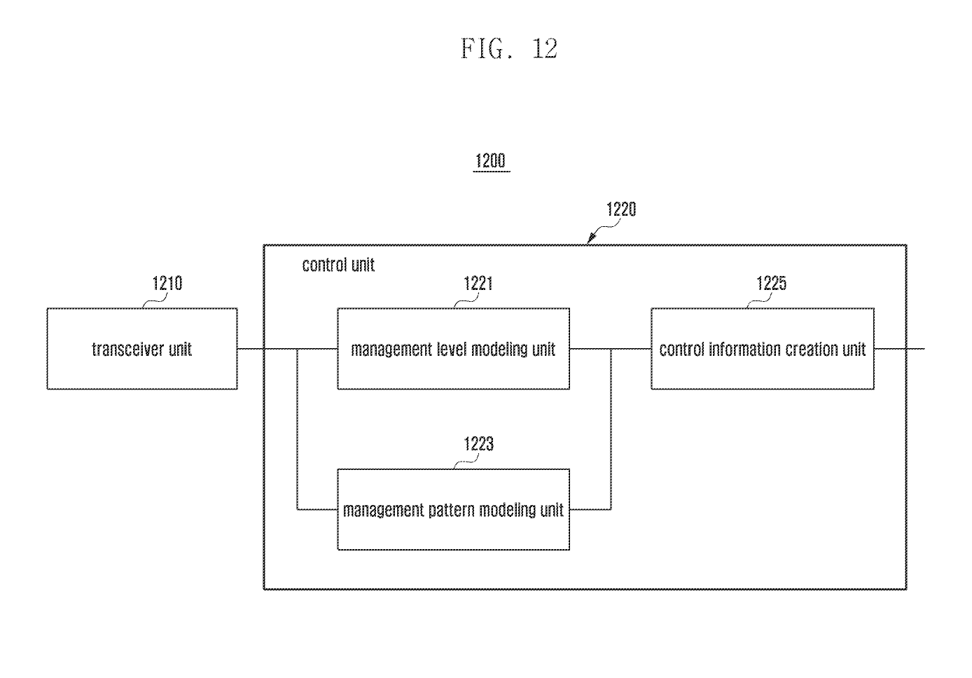

FIG. 12 is a block diagram illustrating an internal structure of a device managing server according to an embodiment of the present disclosure.

Referring to FIG. 12, the server 1200 may be formed of a transceiver unit 1210 configured to transmit or receive data and a control unit 1220 configured to create device power control information.

The transceiver unit 1210 may transmit or receive at least one of pricing information, building related information, user information, and device information. Additionally, the transceiver unit 1210 may transmit or receive the result of the management level modeling process to or from other server. Also, the transceiver unit 1210 may transmit the result of the management level modeling process to the device. Also, the transceiver unit 1210 may transmit the device power control information created depending on the management level modeling process to the device. Also, the transceiver unit 1210 may receive an event signal when a specific event occurs. When a specific event signal is received, the transceiver unit 1210 may transmit device information and user information to the control unit 1220 and also transmit information for instructing the creation of new device power control information to the control unit 1220.

The control unit 1220 includes a management level modeling unit 1221 configured to perform the management level modeling process, a management pattern modeling unit 1223 configured to analyze the device usage information, and a control information creation unit 1225 configured to create the device power control information.

The management level modeling unit 1221 may be configured to perform the management level modeling process by using the device information received from the transceiver unit 1210 and also to transmit the modeling result to the control information creation unit 1225. The management level modeling unit 1221 may be further configured to store the result of the management level modeling process and to transmit the stored result to the control information creation unit 1225 periodically or in response to the occurrence of a specific event.

The management pattern modeling unit 1223 may be configured to obtain the device manage pattern from the user's device usage information received from the transceiver unit 1210. The management pattern modeling unit 1223 may be further configured to transmit the obtained pattern to the control information creation unit 1225 when a specific event occurs.

The control information creation unit 1225 may be configured to create the device power control information. Specifically, the control information creation unit 1225 receives a modeling result from the management level modeling unit 1221 and sets constraints. Then the control information creation unit 1225 creates candidates for the DC change information that satisfies the constraints and determines a specific candidate incurring the minimum electricity price as the device power control information. Additionally, when a specific event occurs, the control information creation unit 1225 may create new device power control information by using the management pattern received from the management pattern modeling unit 1223.

Meanwhile, the control unit 1220 can control the device by using the created device power control information.

According to an embodiment of the present disclosure, the server can create DC change information based on a time-dependent pricing scheme, device information and device usage information. The use of DC change information may reduce power consumption and consume electric power with the minimum price.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A server of a device management system based on device power information, the server comprising:
a transceiver unit configured to receive information used for creating device power control information that is used for changing a power mode between alternating current (AC) power and direct current (DC) power to incur a minimum price; and
a control unit configured to:
calculate a plurality of times a device is capable of operating with DC power, based on a plurality of operating rates of at least one component of the device obtained from the received information,
create first device power control information based on a battery available time selected from the calculated plurality of times by a predetermined policy, and
control the device according to the created first device power control information.

2. The server of claim 1, wherein the control unit is further configured to control the transceiver unit to receive at least one of pricing information, building related information, user information, and device information.

3. The server of claim 1, wherein the control unit is further configured to create the first device power control information periodically or in response to a specific event.

4. The server of claim 3, wherein the control unit is further configured to determine that the specific event occurs when a demand response signal for controlling power usage is received.

5. The server of claim 1, wherein the control unit is further configured to:
set constraints based on the selected battery available time,
create a plurality of candidates for DC change information that satisfies the constraints,
calculate an electricity price of each candidate, and
determine, as device control information, the DC change information that incurs the minimum price from among the calculated electricity prices.

6. The server of claim 5, wherein the control unit is further configured to set, as the constraints, a condition that a time when using DC power does not exceed the selected battery available time.

7. The server of claim 5, wherein the control unit is further configured to calculate the electricity price by multiplying an electricity price per hour and a difference between AC power per hour and DC power per hour, and then adding up multiplication results.

8. The server of claim 3, wherein the control unit is further configured to:
determine a new battery available time when the specific event occurs,
create the first device power control information based on the determined new battery available time, and
control the device according to the created first device power control information.

9. The server of claim 8, wherein the control unit is further configured to:
analyze device usage information,
determine an operating rate of a device component by using an analysis result, and
determine the battery available time based on the determined operating rate.

10. The server of claim 8, wherein the control unit is further configured to:
set constraints based on the determined new battery available time,
create a plurality of candidates for DC change information that satisfies the constraints,
calculate an electricity price of each candidate, and
determine, as device control information, the DC change information that incurs the minimum price from among the calculated electricity prices.

11. The server of claim 10, wherein the control unit is further configured to set, as the constraints, a condition that a time using DC power does not exceed the determined new battery available time.

12. The server of claim 1, wherein if the device has no battery, the control unit is further configured to create second device power control information when creating the first device power control information.

13. The server of claim 12, wherein the control unit is further configured to:
set constraints based on the selected battery available time,
create a plurality of candidates for power usage control information that satisfies the constraints,
calculate an electricity price of each candidate, and
determine, as the second device power control information, the power usage control information that incurs the minimum price from among the calculated electricity prices.

14. The server of claim 13, wherein the control unit is further configured to set, as the constraints, a condition that a time using DC power does not exceed the selected battery available time.

15. A device of a device management system based on device power information, the device comprising:
a transmission unit configured to transmit information used for creating device power control information that is used for changing a power mode between alternating current (AC) power and direct current (DC) power to incur a minimum price; and
a control unit configured to:
receive a result of calculating a plurality of times a device is capable of operating with DC power, based on a plurality of operating rates of at least one component of the device obtained from the received information,
receive first device power control information created depending on a battery available time selected from the calculated plurality of times by a predetermined policy, and
control the device according to the received first device power control information.

16. A device management method of a server based on device power information, the method comprising:
receiving information used for creating device power control information that is used for changing a power mode between alternating current (AC) power and direct current (DC) power to incur a minimum price;
calculating a plurality of times a device is capable of operating with DC power, based on a plurality of operating rates of at least one component of the device obtained from the received information;
creating first device power control information based on a battery available time selected from the calculated plurality of times by a predetermined policy; and
controlling the device according to the created first device power control information.

17. The method of claim 16, wherein the receiving of the information includes receiving at least one of pricing information, building related information, user information, and device information.

18. The method of claim 16, wherein the creating of the first device power control information is performed periodically or in response to a specific event.

19. The method of claim 18, wherein the specific event includes receiving a demand response signal for controlling power usage.

20. The method of claim 16, wherein the creating of the first device power control information includes:
setting constraints based on the selected battery available time;
creating a plurality of candidates for DC change information that satisfies the constraints;
calculating an electricity price of each candidate; and
determining, as device control information, the DC change information that incurs the minimum price from among the calculated electricity prices.

21. The method of claim 20, wherein the constraints include a condition that a time when using DC power does not exceed the selected battery available time.

22. The method of claim 20, wherein the calculating of the electricity price is performed by multiplying an electricity price per hour and a difference between AC power per hour and DC power per hour, and then adding up multiplication results.

23. The method of claim 18, further comprising:
when the specific event occurs, determining a new battery available time;
creating the first device power control information based on the determined new battery available time; and
controlling the device according to the created first device power control information.

24. The method of claim 23, wherein the determining comprises:
analyzing device usage information;
determining an operating rate of a device component by using an analysis result; and
determining the battery available time based on the determined operating rate.

25. The method of claim 23, wherein the creating of the first device power control information comprises:
setting constraints based on the determined new battery available time;
creating a plurality of candidates for DC change information that satisfies the constraints;
calculating an electricity price of each candidate; and
determining, as device control information, the DC change information that incurs the minimum price from among the calculated electricity prices.

26. The method of claim 25, wherein the constraints include a condition that a time using DC power does not exceed the determined new battery available time.

27. The method of claim 16, wherein if the device has no battery, the creating of the first device power control information comprises creating second device power control information.

28. The method of claim 27, wherein the creating of the second device power control information comprises:
setting constraints based on the selected battery available time;
creating a plurality of candidates for power usage control information that satisfies the constraints;
calculating an electricity price of each candidate; and
determining, as the second device power control information, the power usage control information that incurs the minimum price from among the calculated electricity prices.

29. The method of claim 28, wherein the constraints include a condition that a time using DC power does not exceed the selected battery available time.

30. A management method of a device based on device power information, the method comprising:
transmitting information used for creating device power control information that is used for changing a power mode between alternating current (AC) power and direct current (DC) power to incur a minimum price;
receiving a result of calculating a plurality of times a device is capable of operating with DC power, based on a plurality of operating rates of at least one component of the device obtained from the received information;
receiving first device power control information created depending on a battery available time selected from the calculated plurality of times by a predetermined policy; and
controlling the device according to the received first device power control information.
